(19) United States
(12) Patent Application Publication
(10) Pub. No.: US 2013/0091184 A1
(43) Pub. Date: Apr. 11, 2013

(54) CORRELATING INDEPENDENT SCHEMA MAPPINGS

(71) Applicants: Bogdan ALEXE, San Jose, CA (US); Mauricio A. HERNANDEZ, Gilroy, CA (US); Lucian POPA, San Jose, CA (US); Wang-Chiew TAN, San Jose, CA (US)

(72) Inventors: Bogdan ALEXE, San Jose, CA (US); Mauricio A. HERNANDEZ, Gilroy, CA (US); Lucian POPA, San Jose, CA (US); Wang-Chiew TAN, San Jose, CA (US)

(73) Assignee: INTERNATIONAL BUSINESS MACHINES CORPORATION, Armonk, NY (US)

(21) Appl. No.: 13/269,901

(22) Filed: Oct. 10, 2011

(51) Int. Cl. G06F 7/00

(52) U.S. Cl. 707/809; 707/E17.044

(57) ABSTRACT

Embodiments of the invention relate to correlating schema mappings. In one embodiment, a set of schema mappings over a source schema and a target schema are received. Each of the schema mappings is decomposed into a basic schema mapping. A first set and second set of relations re determined for the source schema and the target schema, respectively. Each relation in the first set of relations is paired to at least one relation in the second set of relations. The pairing forms multiple relation pairs between the first set and second of relations in the form of (T, T′), where T is a source portion of a relation pair and T′ is a target portion of the relation pair. A set of basic schema mappings is identified that matches the relation pair. Each basic schema mapping is merged into a single schema mapping.

### STATEMENT REGARDING FEDERALLY SPONSORED RESEARCH OR DEVELOPMENT

This invention was made with Government support under Contract No.: FA9550-07-1-0223, FA9550-06-1-0226 Part VI, Article 20 of FA9550-06-1-0226 awarded by U.S. Air Force, Office of Scientific Research. The Government has certain rights in this invention.

### BACKGROUND

The present invention generally relates to schema mappings, and more particularly relates to correlating schema mappings.

Schema mappings are essential building blocks for information integration. One of the main steps in the integration or exchange of data is to design the mappings that describe the desired relationships between the various source schemas or source formats and the target schema. Once the mappings are established they can be used either to support query answering on the (virtual) target schema, a process that is traditionally called data integration (See, for example, M. Lenzerini: Data Integration: A Theoretical Perspective, PODS, pages 233-246, 2002, which is hereby incorporated by reference in its entirety), or to physically transform the source data into the target format, a process referred to as data exchange (See, for example, R. Fagin, Ph. G. Kolaitis, R. J. Miller, and L. Popa: Data Exchange: Semantics and Query Answering, TCS, 336(1):89-124, 2005, which is hereby incorporated by reference in its entirety).

### BRIEF SUMMARY

In one embodiment a method is disclosed. The method comprises receiving a set of schema mappings over a source schema and a target schema. Each of the schema mapping is decomposed into a basic schema mapping that specifies a mapping behavior for a single target relation and comprises a description of attributes within the single target relation. A plurality of basic schema mappings is generated as a result of the schema mappings being decomposed. A first set of relations is determined for the source schema and a second set of relations is determined for the target schema. The first set of relations and the second set of relations are related by referential constraints within the source schema and the target schema. Each relation in the first set of relations is paired to at least one relation in the second set of relations. The pairing forms a plurality of relation pairs between the first set of relations and the second set of relations in the form of (T, T′), where T is a source portion of a relation pair and T′ is a target portion of the relation pair. A set of basic schema mappings from the plurality of basic schema mappings is identified, for at least on relation pair, that matches the relation pair. Each basic schema mapping in the set of basic schema mappings is merged into a single schema mapping.

In another embodiment a system is disclosed. The system comprises memory and a processor that is communicatively coupled to the memory. A schema mapping merger is communicatively coupled to the memory and the processor. The schema mapping merger is configured to receive a set of schema mappings over a source schema and a target schema. Each of the schema mapping is decomposed into a basic schema mapping that specifies a mapping behavior for a single target relation and comprises a description of attributes within the single target relation. A plurality of basic schema mappings is generated as a result of the schema mappings being decomposed. A first set of relations is determined for the source schema and a second set of relations is determined for the target schema. The first set of relations and the second set of relations are related by referential constraints within the source schema and the target schema. Each relation in the first set of relations is paired to at least one relation in the second set of relations. The pairing forms a plurality of relation pairs between the first set of relations and the second set of relations in the form of (T, T′), where T is a source portion of a relation pair and T′ is a target portion of the relation pair. A set of basic schema mappings from the plurality of basic schema mappings is identified, for at least on relation pair, that matches the relation pair. Each basic schema mapping in the set of basic schema mappings is merged into a single schema mapping.

In yet another embodiment, a computer program product comprising a computer readable storage medium having computer readable program code embodied therewith is disclosed. The computer readable program code comprises computer readable program code configured to receive a set of schema mappings over a source schema and a target schema. Each of the schema mapping is decomposed into a basic schema mapping that specifies a mapping behavior for a single target relation and comprises a description of attributes within the single target relation. A plurality of basic schema mappings is generated as a result of the schema mappings being decomposed. A first set of relations is determined for the source schema and a second set of relations is determined for the target schema. The first set of relations and the second set of relations are related by referential constraints within the source schema and the target schema. Each relation in the first set of relations is paired to at least one relation in the second set of relations. The pairing forms a plurality of relation pairs between the first set of relations and the second set of relations in the form of (T, T′), where T is a source portion of a relation pair and T′ is a target portion of the relation pair. A set of basic schema mappings from the plurality of basic schema mappings is identified, for at least on relation pair, that matches the relation pair. Each basic schema mapping in the set of basic schema mappings is merged into a single schema mapping.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention, in which:

FIG. 1 is a block diagram illustrating one example of an operating environment according to one embodiment of the present invention;

FIG. 2 illustrates a transformation flow from a first schema to a third schema according to one embodiment of the present invention;

FIG. 3 illustrates schema mappings from a from a first schema to a second schema shown in FIG. 2 according to one embodiment of the present invention;

FIG. 4 illustrates an instance of the first schema in FIG. 2 and two instances of the second schema in FIG. 2 according to one embodiment of the present invention;

FIG. 5 illustrates one example of an output resulting from a schema mapping correlation operation being performed on the schemas mappings in FIG. 3 according to one embodiment of the present invention;

FIG. 6 illustrates one example of pseudo code for an overall algorithm for performing a schema mapping correlation operation according to one embodiment of the present invention;

FIG. 7 illustrates one example of more detailed pseudo code for a schema mapping decomposition process performed as part of the schema mapping correlation operation according to one embodiment of the present invention;

FIG. 8 illustrates one example of more detailed pseudo code for a schema mapping matching process performed as part of the schema mapping correlation operation according to one embodiment of the present invention;

FIG. 9 illustrates one example of more detailed pseudo code for a schema mapping merging process performed as part of the schema mapping correlation operation according to one embodiment of the present invention;

FIGS. 10-11 illustrate one example of more detailed pseudo code for a syntactic simplification process performed as part of the schema mapping correlation operation according to one embodiment of the present invention;

FIG. 13 illustrates a graph showing the improvement in quality of data generated by the schema mapping correlation operation versus a conventional mapping technique;

FIG. 14 is an operational flow diagram illustrating one example of a process for correlating schema mappings according to one embodiment of the present invention; and

FIG. 15 is a block diagram illustrating a detailed view of an information processing system according to one embodiment of the present invention.

### DETAILED DESCRIPTION

### Operating Environment

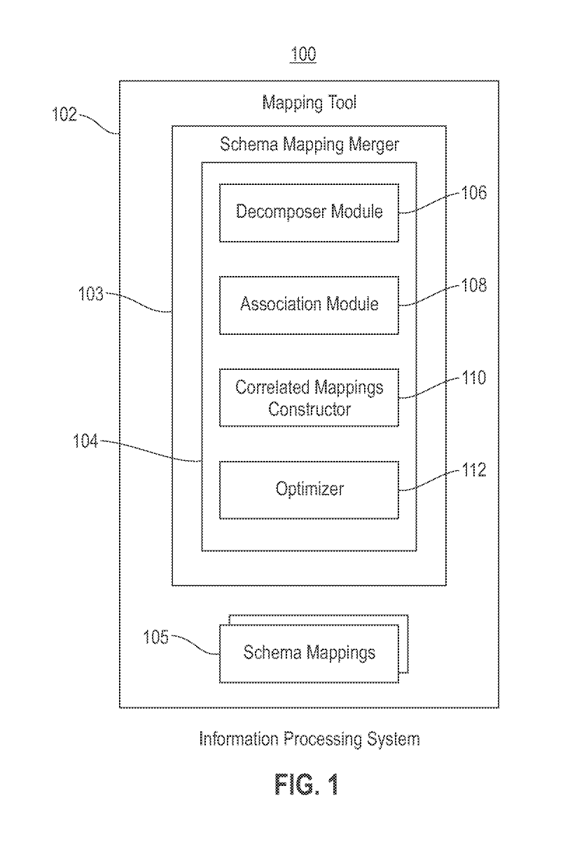

FIG. 1 shows one example of an operating environment 100 applicable to various embodiments of the present invention. The operating environment 100, in one embodiment, comprises one or more information processing systems 102. The information processing system 102 comprises a mapping tool 103 and schema mappings 105. The mapping tool 103 comprises, among other components, a schema mapping merger 104. The schema mapping merger 104, in one embodiment, takes arbitrary mapping assertions (and not just correspondences) as input. As will be discussed in greater detail below, the schema mapping merger 104 performs a map merging process that correlates multiple independently designed schema mappings 105 of smaller scope into larger schema mappings. This allows a more modular construction of complex mappings from various types of smaller mappings such as schema correspondences produced by a schema matcher or pre-existing mappings and/or customized mappings that were designed by either a human user or via mapping tools. The schema mapping merger 104 automatically correlates the input mappings in a meaningful way.

The schema mapping merger 104 also enables a new “divide-and-merge” paradigm for mapping creation. The design is divided into smaller components that are easier to create and understand. The schema mapping merger 104 uses these smaller components to automatically generate a meaningful overall mapping. The schema mapping merger 104 improves the quality of the schema mappings by significantly increasing the similarity between the input source instance and the generated target instance. The operation(s) performed by the schema mapping merging 104 are herein referred to as the “MapMerge” operation(s).

The schema mapping merger 104, in one embodiment, comprises a decomposer module 106 that decomposes input mapping assertions into basic components that are intuitively easier to merge. The schema mapping merger 104 also comprises an association module 108 that utilizes an algorithm such as, but not limited to, a chase algorithm to compute associations (referred to here as “tableaux”) from source and target schemas, as well as from source and target assertions of the input mappings. By pairing source and target tableaux the schema mapping merger 104 obtains all (or at least a portion of) the possible skeletons of mappings.

The schema mapping merger 104 further comprises a correlated mappings constructor 110. The correlated mappings constructor 110 constructs correlated mappings by taking, for each skeleton, the union of all (or at least a portion of) the basic components generated by the decomposer 104 that “match” the skeleton. The schema mapping merger 104 further comprises an optimizer 112 that eliminates residual equality constraints and also flags conflicts that may arise and that need to be addressed by the user. These conflicts occur when multiple mappings that map to the same portion of the target schema contribute with different, irreconcilable behaviors. The schema mapping merger 104 and its components are discussed in greater detail below.

### Overview

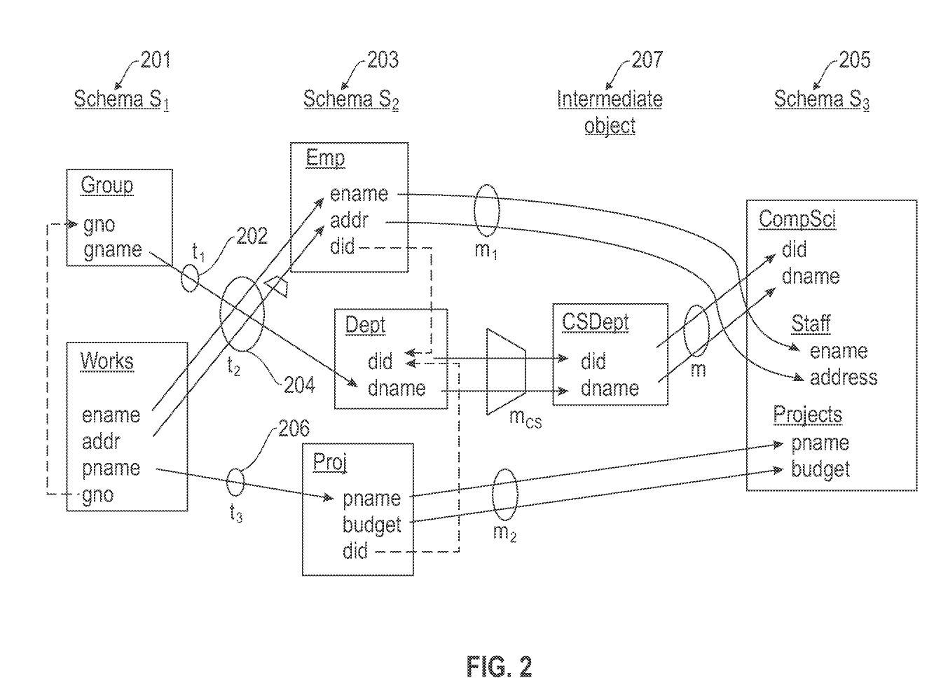

Consider a mapping scenario between the schemas S₁ 201 and S₂ 203 as shown in FIG. 2. Two source relations, Group and Works, are used to restructure data to three target relations, Emp, Dept, and Proj. In this example, Group (similar to Dept) represents groups of scientists sharing a common area (e.g., a database group, a CS group, etc.). The dotted arrows represent foreign key constraints in the schemas.

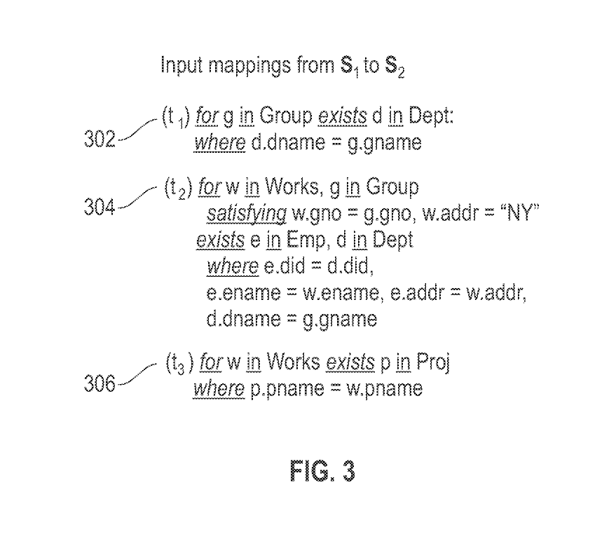

Independent Mappings: assume the existence of the following (independent) schema mappings from S₁ 201 to S₂ 203. The first mapping is the constraint t₁ 302 under the input mappings from S₁ 201 to S₂ 203 shown in FIG. 3. The constraint t₁ 302 corresponds to the arrow t₁ 202 in FIG. 2. This constraint requires every tuple in Group to be mapped to a tuple in Dept such that the group name (gname) becomes department name (dname). The second mapping is the constraint t₂ 304, which is more complex and corresponds to the group of arrows t₂ 204 in FIG. 2. This constraint involves a custom filter condition; every pair of joining tuples of Works and Group for which the addr value is “NY” must be mapped into two tuples of Emp and Dept sharing the same did value and with corresponding ename, addr and dname values (note that did is a target-specific field that must exist and plays the role of key/foreign key). Intuitively, t₂ 204 illustrates a pre-existing mapping that a user may have spent time in the past to create. Finally, the third constraint t₃ 306 corresponds to the arrow t₃ 206 and maps pname from Works to Proj. This is an example of a correspondence that is introduced by a user after loading t₁ 302 and the pre-existing mapping t₂ 304 into the mapping tool 103.

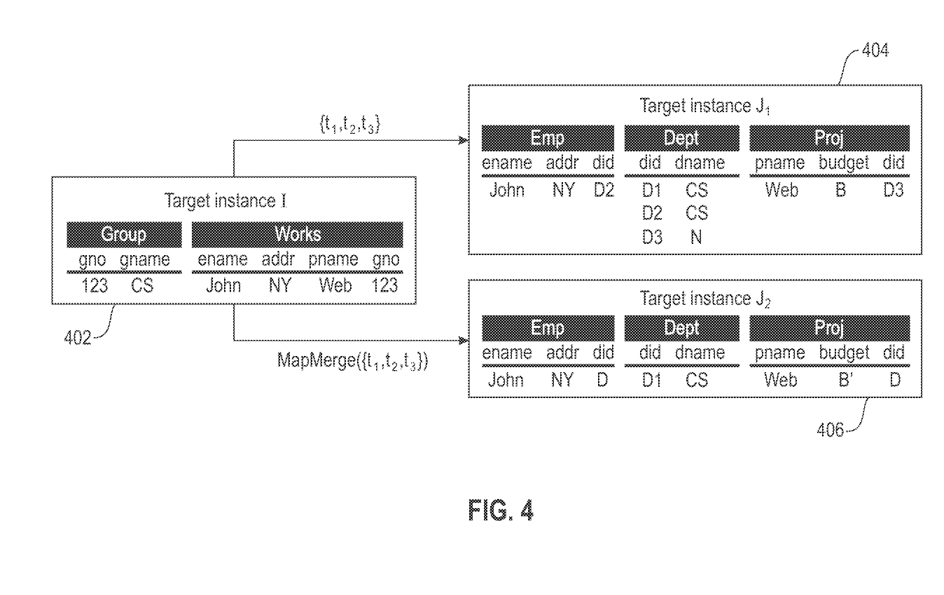

In one example, the system (re)generate a “good” overall schema mapping from S₁ 201 to S₂ 203 based on its input mappings. It should be noted that the input mappings, when considered in isolation, do not generate an ideal target instance. For example, consider the source instance I 402 in FIG. 4. The target instance that is obtained by minimally enforcing the constraints {t₁, t₂, t₃} is the instance J₁ 404 also shown in FIG. 4. The first Dept tuple is obtained by applying t₁ 302 on the Group tuple (123, CS). There, D1 represents some did value that must be associated with CS in this tuple. Similarly, the Proj tuple with some unspecified value B for budget and a did value of D3 is obtained via t₃ 306. The Emp tuple together with the second Dept tuple are obtained based on t₂ 304. As needed by t₂ 304 these tuples are linked via the same did value D2. Finally, to obtain a target instance that satisfies all (or at least a portion of) the foreign key constraints a third tuple in Dept is needed that includes D3 together with some unspecified department name N.

Since the three mapping constraints are not correlated, the three did values (D1, D2, D3) are distinct (there is no requirement that they must be equal). As a result, the target instance J₁ 404 exhibits the typical problems that arise when uncorrelated mappings are used to transform data: (1) duplication of data (e.g., multiple Dept tuples for CS with different did values), and (2) loss of associations where tuples are not linked correctly to each other (e.g., the association between project name Web and department name CS that existed in the source is lost).

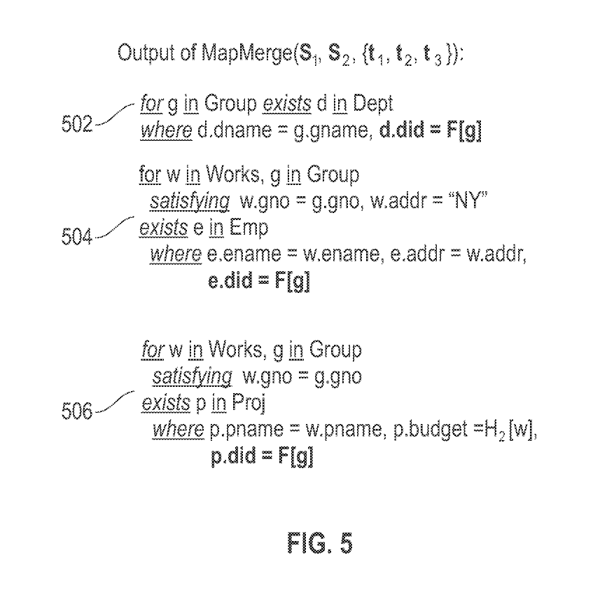

Correlated Mappings via the Schema Mapping Merger 104: consider now the schema mappings that are shown in FIG. 5, which are the result of a mapping process performed by the schema mapping merger 104 on {t₁,t₂,t₃}. The notable difference from the input mappings is that all (or at least a portion of) mappings consistently use the same expression, namely the Skolem term F[g] where g denotes a distinct Group tuple, to give values for the did field. The first mapping 502 is the same as t₁ 302 but makes explicit the fact that did is F[g]. This mapping creates a unique Dept tuple for each distinct Group tuple. The second mapping 504 is (almost) like t₂ 304 with the additional use of the same Skolem term F[g]. Moreover, it also drops the existence requirement for Dept (since this is now implied by the first mapping). Finally, the third mapping 506 differs from t₃ 306 by incorporating a join with Group before it can actually use the Skolem term F[g]. As an additional artifact of the MapMerge operation, which is discussed in greater detail below, it also includes a Skolem term H₁[w] that assigns values for budget.

The target instance that is obtained by applying the result of the MapMerge operation is the instance J₂ 406 shown in FIG. 4. The data associations that exist in the source are now correctly preserved in the target. For example, Web is linked to the CS tuple (via D) and also John is linked to the CS tuple (via the same D). Furthermore, there is no duplication of Dept tuples.

Flows of Mappings: taking the idea of mapping reuse and modularity one step further, an even more compelling use case for the MapMerge operation in conjunction with mapping composition is the flow-of-mappings scenario. With respect to mapping composition see, for example, R. Fagin, P. G. Kolaitis, L. Popa, and W. Tan: Composing Schema Mappings: Second-Order Dependencies to the Rescue, TODS, 30(4):994-1055, 2005; J. Madhavan and A. Y. Halevy: Composing Mappings Among Data Sources, VLDB, pages 572-583, 2003; and A. Nash, P. A. Bernstein, and S. Melnik: Composition of Mappings given by Embedded Dependencies, PODS, pages 172-183, 2005, which are hereby incorporated by reference in their entireties. With respect to the flow-of-mappings-scenario see, for example, A. Nash and P. A. Bernstein and S. Melnik: Composition of Mappings given by Embedded Dependencies, PODS, pages 172-183, 2005, which is hereby incorporated by reference in its entirety.

One embodiment produces a data transformation from the source to the target, the process can be decomposed into several simpler stages, where each stage maps from or into some intermediate, possibly simpler schema. Moreover, the simpler mappings and schemas play the role of reusable components that can be applied to build other flows. Such abstraction is directly motivated by the development of real-life, large-scale ETL flows such as those typically developed with IBM Information Server (Datastage), Oracle Warehouse Builder, and others.

For example, consider transforming data from the schema S₁ 201 of FIG. 2 to a new schema S₃ 205, where Staff and Projects information are grouped under CompSci. The mapping or ETL designer may find it easier to first construct the mapping between S₁ 201 and S₂ 203 (it may also be that this mapping may have been derived in a prior design). Furthermore, the schema S₂ 203 is a normalized representation of the data, where Dept, Emp, and Proj correspond directly to the main concepts (or types of data) that are being manipulated. Based on this schema, the designer can then produce a mapping m_{cs} from Dept to a more specialized object CSDept (intermediate object 207) by applying some customized filter condition (e.g., based on the name of the department). The next step is to create the mapping m from CSDept to the target schema. Other independent mappings are similarly defined for Emp and Proj (see m₁ and m₂).

Once these individual mappings are established, the same problem of correlating the mappings arises. In particular, one has to correlate m_{CS} ∘m, which is the result of applying mapping composition to m_{CS} and m, with the mappings m₁ for Emp and m₂ for Proj. This correlation ensures that all (or at least a portion of) employees and projects of computer science departments will be correctly mapped under their correct departments in the target schema.

In this example, composition itself gives another source of mappings to be correlated by the schema mapping merger 104. While similar with composition in that it is an operator on schema mappings, operations of the schema mapping merger 104 are fundamentally different in that they correlate mappings that share the same source schema and the same target schema. In contrast, composition takes two sequential mappings where the target of the first mapping is the source of the second mapping. Nevertheless, the two operators are complementary and together they can play a fundamental role in building data flows.

Preliminaries

A schema consists of a set of relation symbols, each with an associated set of attributes. Moreover, each schema can have a set of inclusion dependencies modeling foreign key constraints. It should be noted that even though the following discussion is directed to a relational case, one or more embodiments are also applicable to the more general case of a nested relational data model (see, for example, L. Popa, Y. Velegrakis, R. J. Miller, M. A. Hernandez, and R. Fagin: Translating Web Data, VLDB, pages 598-609, 2002, which is hereby incorporated by reference in its entirety), where the schemas and mappings can be either relational or XML.

Schema Mappings: a schema mapping is a triple (S,T,Σ) where S is a source schema, T is a target schema, and Σ is a set of second-order tuple generating dependencies (SO tgds). Throughout the following discussion, the following notation is used for expressing SO tgds:

for \vec{x} in \vec{S} satisfying B₁(\vec{x}) exists \vec{y} in T where B₂(\vec{y}) and C(\vec{x}, \vec{y})

Examples of SO tgds in this notation are shown in FIG. 3 and FIG. 5. Here, \vec{S} represents a vector of source relation symbols (possibly repeated), while \vec{x} represents the tuple variables that are bound, correspondingly, to these relations. A similar notation applies for the exists clause. The conditions B₁(\vec{x}) and B₂(\vec{y}) are conjunctions of equalities over the source and target variables, respectively. The condition C(\vec{x},\vec{y}) is a conjunction of equalities that equate target expressions (e.g., y·A) with either source expressions (e.g., x·B) or Skolem terms of the form F[x₁, . . . , xᵢ], where F is a function symbol and x₁, . . . , xᵢ are a subset of the source variables. Skolem terms are used to relate target expressions across different SO tgds. An SO tgd without a Skolem term may also be called a tuple-generating dependency or tgd.

Note that the SO tgds of one or more embodiments do not allow equalities between or with Skolem terms in the satisfying clause. While such equalities may be needed for more general purposes they do not play a role for data exchange and can be eliminated, as observed in C. Yu and L. Popa. Semantic Adaptation of Schema Mappings when Schemas Evolve. VLDB, pages 1006-1017, 2005, which is hereby incorporated by reference in its entirety.

Chase-Based Semantics: the semantics adopted in at least one embodiment for a schema mapping (S,T,Σ) is the standard data-exchange semantics where, given a source instance I, the result of “executing” the mapping is the target instance J that is obtained by chasing I with the dependencies in Σ. Since the dependencies in Σ are SO tgds, an extension of the chase as defined in Fagin et al.: Composing Schema Mappings: Second-Order Dependencies to the Rescue, is used in one embodiment.

The chase provides a way of populating the target instance J in a minimal way, by adding the tuples that are needed by Σ. For every instantiation of the for clause of a dependency in Σ such that the satisfying clause is satisfied but the exists and where clauses are not, the chase adds corresponding tuples to the target relations. Fresh new values (also called labeled nulls) are used to give values for the target attributes for which the dependency does not provide a source expression. Additionally, Skolem terms are instantiated by nulls in a consistent way: a term F[x₁, . . . , xᵢ] is replaced by the same null every time x₁, . . . , xᵢ are instantiated with the same source tuples. Finally, to obtain a valid target instance, the schema mapping merger 104 chase (if needed) with the target constraints.

Using the example given above with respect to FIGS. 2-5, the target instance J₁ 404 is the result of chasing the source instance I 402 with the tgds in FIG. 3 and, additionally, with the foreign key constraints. There, the values D1, D2, D3 are nulls that are generated to fill did values for which the tgds do not provide a source expression. The target instance J₂ 406 is the result of chasing I with the SO tgds in FIG. 5. There, D is a null that corresponds to the Skolem term F[g] where g is instantiated with the sole tuple of Group. It should be noted that be noted that other embodiments utilize other method such as, but not limited to, query generation to achieve a similar result as the chase process. See for example, L. Popa et al.: Translating Web Data; and A. Fuxman, M. A. Hernandez, H. Ho, R. J. Miller, P. Papotti, and L. Popa: Nested Mappings: Schema Mapping Reloaded, VLDB, pages 67-78, 2006, which is hereby incorporated by reference in its entirety.

Correlating Mappings

The following is a more detailed discussion on the MapMerge operation performed by the schema mapping merger 104. As will be shown, the MapMerge operation generates correlations between mappings that preserve the natural data associations in the source without introducing extra associations.

The schema mapping merger 104 exploits the structure and the constraints in the schemas in order to define what natural associations are. Two data elements are considered associated if they are in the same tuple or in two different tuples that are linked via constraints. See, for example, L. Popa et al.: Translating Web Data. This idea provides the first (conceptual) step towards the MapMerge operation. For the example discussed above with respect to FIGS. 2-5, the input mapping t₃ 306 in FIG. 3 is equivalent, in the presence of the source and target constraints, to the following enriched mapping:

t′₃: for w in Works, g in Group satisfying w·gno=g·gno
exists p in Proj, d in Dept
where p·pname=w·pname and p·did=d·did
   If there is a w tuple in Works, there is also a joining tuple g in Group, since gno is a foreign key from Works to Group. Similarly, a tuple p in Proj implies the existence of a joining tuple in Dept, since did is a foreign key from Proj to Dept.

Formally, the above rewriting from t₃ to t′₃ is captured by the chase procedure. See, for example, C. Beeri and M. Y. Vardi: A Proof Procedure for Data Dependencies, JACM, 31(4):718-741, 1984; and D. Maier, A. O. Mendelzon, Y. Sagiv: Testing Implications of Data Dependencies, tods, 4(4):455-469, 1979, which are hereby incorporated by reference in their entireties. The chase is a convenient tool to group together, syntactically, elements of the schema that are associated. The chase by itself, however, does not change the semantics of the mapping. In particular, the above t′₃ does not include any additional mapping behavior from Group to Dept.

The schema mapping merger 104 can also reuse or borrow mapping behavior from a more general mapping to a more specific mapping. The schema mapping merger 104 uses a heuristic that changes the semantics of the entire schema mapping and produces a better one, with consolidated semantics. For example, consider the first mapping constraint 502 in FIG. 5. This constraint (obtained by skolemizing the input t₁) specifies a general mapping behavior from Group to Dept. In particular, it specifies how to create dname and did from the input record. On the other hand, the above t′₃ can be seen as a more specific mapping from a subset of Group (i.e., those groups that have associated Works tuples) to a subset of Dept (i.e., those departments that have associated Proj tuples). At the same time, t′₃ does not specify any concrete mapping for the dname and did fields of Dept. The mapping behavior that is already specified by the more general mapping can then be borrowed. Thus, t′₃ can be enriched to:

t″₃: for w in Works, g in Group satisfying w·gno=g·gno
exists p in Proj, d in Dept
where p·pname=w·pname and p·did=d·did
and d·dname=g·gname and d·did=F[g] and p·did=F[g]
   where two of the last three equalities represent the “borrowed” behavior, while the last equality is obtained automatically by transitivity. Finally, the existence of d in Dept can be dropped with the two conditions for dname and did, since this is repeated behavior that is already captured by the more general mapping from Group to Dept. The resulting constraint is substantially identical (Modulo the absence of H₁[w]) to the third constraint 306 in FIG. 3, now correlated with the first one via F[g]. A similar explanation applies for the second constraint 504 in FIG. 5.

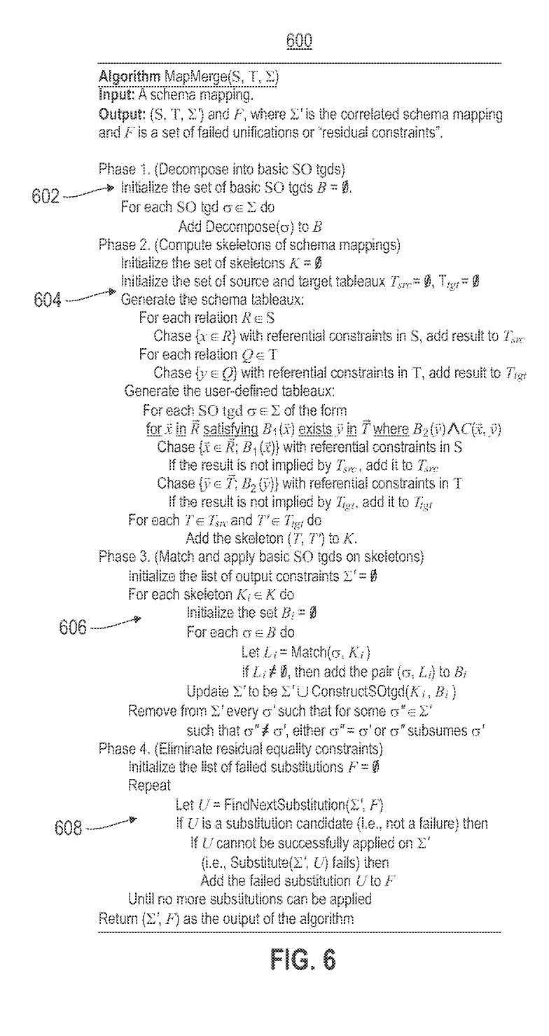

The algorithm utilized by the schema mapping merger 104 for performing the MapMerge operation is more complex than intuitively suggested above, and will now be discussed in greater detail. FIG. 6 shows one example of pseudo code for the overall algorithm 600 utilized by the schema mapping merger 104 for correlating mappings. The algorithm 600 comprises four phases 602, 604, 606, 608. The schema mapping merger 104 takes as input a set {(S,T,Σ₁), . . . , (S,T,Σₙ)} of schema mappings over the same source and target schemas, which is equivalent to taking a single schema mapping (S,T,Σ₁∪ . . . ∪Σₙ) as input. The first phase 602 is performed by the decomposer module 106. In this first phase the decomposer module 106 decomposes each input mapping assertion into basic components that are, intuitively, easier to merge. For example, the algorithm of FIG. 6 shows that the set of basic SO tgds are initialized to B=Ø. Decompose (σ) is added to B for each SO tgd σεΣ.

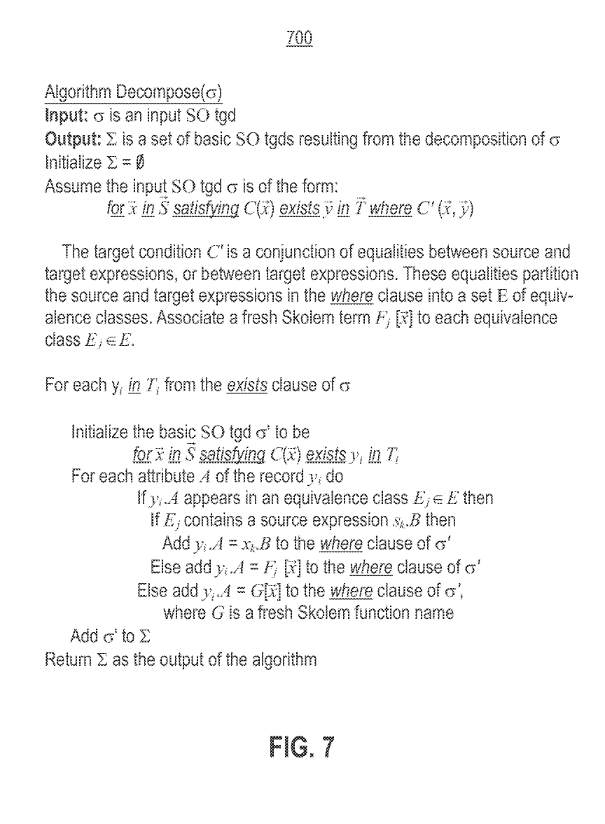

FIG. 7 shows additional pseudo code for a decomposition algorithm 700 performed by the first phase 602 where an input SO tgd is decomposed into its set of basic SO tgds. As can be seen from FIG. 7, the decomposer module 106 decomposes each input SO tgd into a set of simpler SO tgds, called basic SO tgds, that have the same for and satisfying clause as the input SO tgd, but have exactly one relation in the exists clause. The input mappings are broke into atomic components that each specify mapping behavior for a single target relation. This decomposition step subsequently allows the mapping behaviors to be merged even when they come from different input SO tgds.

In addition to being single-relation in the target, each basic SO tgd gives a complete specification of all (or at least a portion of) the attributes of the target relation. More precisely, each basic SO tgd has the form

for \vec{x} in \vec{S} satisfying B₁(\vec{x})

exists y in T where [symbol] _{AεAtts(y)}y·A=e_{A}(\vec{x})

where the conjunction in the where clause contains one equality constraint for each attribute of the record y asserted in the target relation T. The expression e_{A}(\vec{x}) is either a Skolem term or a source expression (e.g., x·B). Part of the role of the decomposition phase is to assign a Skolem term to every target expression y·A for which the initial mapping does not equate it to a source expression.

For the example given above with respect to FIGS. 2-5, the decomposition algorithm 700 shown in FIG. 7 obtains the following basic SO tgds from the input mappings t₁, t₂, and t₃ of FIG. 3:

(b₁): for g in Group exists d in Dept
where d·did=F[g] and d·dname=g·gname

(b₂): for w in Works, g in Group
satisfying w·gno=g·gno and w·addr=“NY”
exists e in Emp
where e·ename=w·ename and e·addr=w·addr and e·did=G[w,g]

(b′₂): for w in Works, g in Group
satisfying w·gno=g·gno and w·addr=“NY”
exists d in Dept
where d·did=G[w,g] and d·dname=g·gname

(b₃): for w in Works exists p in Proj
where p·pname=w·pname and p·budget=H₁[w] and p·did=H₂ [w]

The basic SO tgd b₁ is obtained from t₁; the main difference is that d·did, whose value was unspecified by t₁, is now explicitly assigned the Skolem term F[g]. The only argument to F is g because g is the only record variable that occurs in the for clause of t₁. Similarly, the basic SO tgd b₃ is obtained from t₃, with the difference being that p·budget and p·did are now explicitly assigned the Skolem terms H₁[w] and, respectively, H₂[w].

In the case of t₂, it should be noted that there are two existentially quantified variables, one for Emp and one for Dept. Hence, the decomposition algorithm generates two basic SO tgds: the first one maps into Emp and the second one maps into Dept. Observe that b₂ and b₂, are correlated and share a common Skolem term G[w,g] that is assigned to both e·did and d·did. Thus, the association between e·did and d·did in the original schema mapping t₂ is maintained in the basic SO tgds b₂ and b_{2′}.

In general, the decomposition process ensures that associations between target facts that are asserted by the original schema mapping are not lost. The process is similar to the Skolemization procedure that transforms first order tgds with existentially quantified variables into second order tgds with Skolem functions. After such Skolemization, all (or at least a portion of) the target relations can be separated since they are correlated via Skolem functions. Therefore, the set of basic SO tgds that results after decomposition is equivalent to the input set of mappings.

The second phase 604 is performed by the association module 108. In this phase the association module 108 applies a chase algorithm to compute associations (tableaux), from the source and target schemas, as well as from the source and target assertions of the input mappings. As discussed above, by pairing source and target tableaux, all (or at least a portion of) the possible skeletons of mappings are obtained. The algorithm 600 of FIG. 6 shows that the set of skeletons K is initialized to K=0. The set of source tableaux T_{src} and target tableaux T_{tgt} are initialized to T_{src}=0 and T_{tgt}=0, respectively. The schema mapping merger 104 then generates the schema tableaux as follows. For each relation RεS, {xεR} is chased with referential constraints in S. The result is then added to T_{src}. For each relation QεT, {yεQ} is chased with referential constraints in T. The result is then added to T_{tgt}. The schema mapping merger 104 also generates the user-defined tableaux as follows. For each So tgd σεΣ of the form for \vec{x} in R satisfying B₁(\vec{x}) exists \vec{y} in \vec{T} where B₂ (\vec{y}) [symbol] C(\vec{x}, \vec{y}), the schema mapping merger 104 chases {\vec{x}ε\vec{R}; B₁(\vec{x})} with referential constraints in S. If the result is not implied by T_{src} the result is added to T_{src}. The schema mapping merger 104 chases {\vec{y}ε\vec{T};B₂(\vec{y})} with referential constraints in T. If the result is not implied by T_{tgt} the result is added to T_{src}. For each TεT_{src} and T′εT_{tgt} the schema mapping merger 104 adds the skeleton (T,T′) to K.

In more detail, the association module 108 applies the chase algorithm to compute syntactic associations (tableaux), from each of the schemas and from the input mappings. A schema tableau is constructed by taking each relation symbol in the schema and chasing it with all (or at least a portion of) the referential constraints that apply. The result of such chase is a tableau that incorporates a set of relations that is closed under referential constraints, together with the join conditions that relate those relations. For each relation symbol in the schema, there is one schema tableau. In order to guarantee termination, the chase is stopped whenever cycles are encountered in the referential constraints. See, for example, A. Fuxman et al. and L. Popa et al. In the example given above with respect to FIG. 2-5, there are two source schema tableaux and three target schema tableaux as follows:

T₁={gεGroup}

T₂={wεWorks, gεGroup; w·gno=g·gno}

T₃={dεDept}

T₄={eεEmp, dεDept; e·did=d·did}

T₅={pεProj, dεDept; p·did=d·did}

Schema tableaux represent the categories of data that can exist according to the schema. A Group record can exist independently of records in other relations (hence, the tableau T₁). However, the existence of a Works record implies that there must exist a corresponding Group record with identical gno (hence, the tableau T₂).

Since the MapMerge operation takes as input arbitrary mapping assertions, user-defined mapping tableaux are also generated, which are obtained by chasing the source and target assertions of the input mappings with the referential constraints that are applicable from the schemas. The notion of user-defined tableaux is similar to the notion of user associations in Y. Velegrakis, R. J. Miller, and L. Popa: Mapping Adaptation under Evolving Schemas, VLDB, pages 584-595, 2003, which is hereby incorporated by reference in its entirety. In the example given above with respect to FIGS. 2-5, there is only one new tableau based on the source assertions of the input mapping t₂:

T_{2′}={wεWorks, gεGroup; w·gno=g·gno, w·addr=“NY”}

Furthermore, the association module 108 then pairs every source tableau with every target tableau to form a skeleton. Each skeleton represents the empty shell of a candidate mapping. For the example in FIGS. 2-5, the set of all (or at least a portion of) skeletons at the end of the second phase 604 is: {(T₁,T₃), (T₁,T₄), (T₁,T₅), (T₂,T₃), (T₂,T₄), (T₂,T₅), (T_{2′},T₃), (T_{2′},T₄), (T_{2′},T₅)}.

In the third phase 606, which is performed by the correlated mappings constructor 110, constructs correlated mappings. In this phase 606, the correlated mappings constructor 110, for each skeleton, takes the union of all (or at least a portion of) the basic components generated in the first phase 602 that “match” the skeleton. In particular, the algorithm 600 of FIG. 6 shows that the schema mapping merger 104 initializes the list of output constraints Σ′ to Σ′=Ø. For each skeleton KᵢεK the schema mapping merger 104 initializes the set Bᵢ=Ø. Then for each σεB the schema mapping merger 104 lets Lᵢ=Match(σ,K₁). If L Lᵢ=Ø then the schema mapping merger 104 adds the pair (σ,Lᵢ) to Bᵢ. The schema mapping merger 104 then updates E′ to be Σ′∪ConstructSOtgd(Kᵢ,Bᵢ). The schema mapping merger 104 then removes from Σ′ every σ′ such that for some σ″εΣ′ such that σ″≠σ′, either σ″|=σ′ or σ″ subsumes σ′.

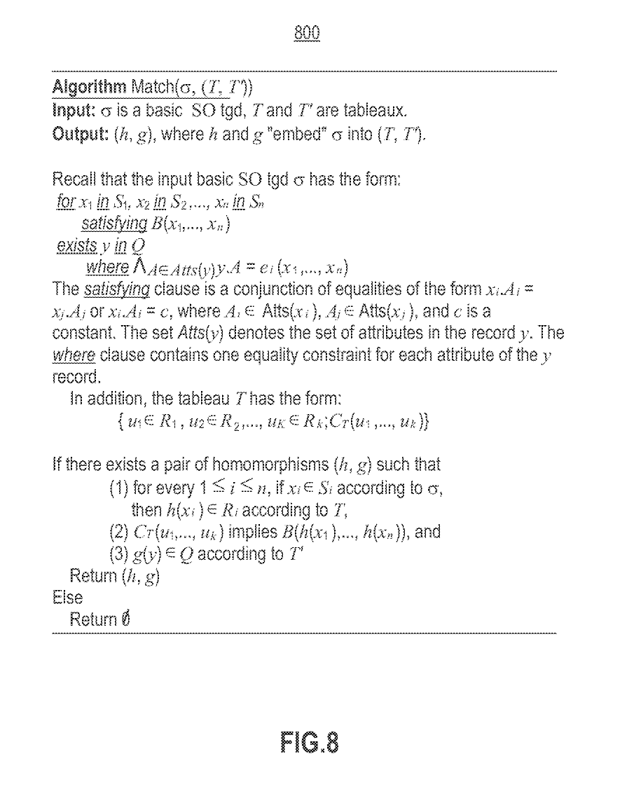

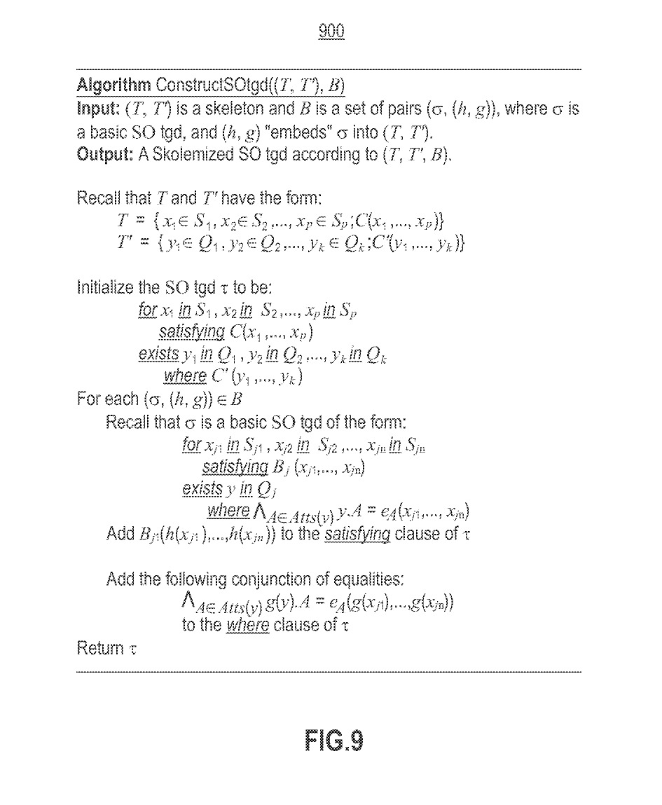

FIGS. 8-9 show more detailed pseudo code of algorithms 800, 900 for the above processes performed during the third phase 606. As can be seen from FIGS. 8-9, the correlated mappings constructor 110, for each skeleton, first finds the set of basic SO tgds that “match” the skeleton. Then, for each skeleton, the correlated mappings constructor 110 applies the basic SO tgds that were found and constructs a merged SO tgd. The resulting SO tgd is the “conjunction” of all (or at least a portion of) the basic SO tgds that were found matching.

With respect to matching, a basic SO tgd σ matches a skeleton (T,T′) if there is a pair (h,g) of homomorphisms that “embed” σ into (T,T′). This translates into two conditions. First, the for and satisfying clause of σ are embedded into T via the homomorphism h. This means that h maps the variables in the for clause of σ to variables of T such that relation symbols are respected and, moreover, the satisfying clause of σ (after applying h) is implied by the conditions of T. Additionally, the exists clause of σ must be embedded into T′ via the homomorphism g. Since σ is a basic SO tgd and there is only one relation in its exists clause, the latter condition essentially states that the target relation in σ must occur in T′.

For the example discussed above with respect to FIGS. 2-5, it is easy to see that the basic SO tgd b₁ matches the skeleton (T₁,T₃). In fact, b₁ matches every skeleton from the second phase 604. On the other hand, the basic SO tgd b₂ matches only the skeleton (T_{2′},T₄) under the homomorphisms (h₁,h₂), where h₁={w [symbol] w,g [symbol] g} and h₂={e [symbol] e}. Altogether, the following matching of basic SO tgds on skeletons is obtained:

(T₁,T₃,b₁) (T₁,T₄,b₁) (T₁,T₅,b₁) (T₂,T₃,b₁)

(T₂,T₄,b₁) (T₂,T₅,b₁ [symbol] b₃) (T′₂,T₃,b₁ [symbol] b′₂)
(T′₂,T₄,b₁ [symbol] b₂ [symbol] b′₂) (T′₂,T₅,b₁ [symbol] b′₂ [symbol] b₃)

Note that the basic SO tgds that match a given skeleton may actually come from different input mappings. For example, each of the basic SO tgds that match (T_{2′},T₅) comes from a separate input mapping (from t₁, t₂, and t₃, respectively). In a sense, behaviors from multiple input mappings are aggregated in a given skeleton.

With respect to computing merged SO tgds, the correlated mappings constructor 110, for each skeleton along with the matching basic SO tgds, constructs a “merged” SO tgd. For the example discussed above with respect to FIGS. 2-5, the following SO tgd s₈ is constructed from the eighth triple (T_{2′},T₄,b₁ [symbol] b₂ [symbol] b₂) shown earlier.

(s₈) for w in Works, g in Group
satisfying w·gno=g·gno and w·addr=“NY”
exists e in Emp, d in Dept
where e·did=d·did
   and d·did=F[g] and d·dname=g·gname
   and e·ename=w·ename and e·addr=w·addr and e·did=G[w,g]
   and d·did=G[w,g]

The variable bindings in the source and target tableaux are taken literally and added to the for and, respectively, exists clause of the new SO tgd. The equalities in T_{2′} and T₄ are also taken literally and added to the satisfying and, respectively, where clause of the SO tgd. More interestingly, for every basic SO tgd a that matches the skeleton (T_{2′}, T₄), the correlated mappings constructor 110 takes the where clause of σ (after applying the respective homomorphisms) and add it to the where clause of the new SO tgd. Note that, by definition of matching, the satisfying clause of σ is automatically implied by the conditions in the source tableau. The last three lines in the above SO tgd incorporate conditions taken from each of the basic SO tgds that match (T_{2′},T₄) (i.e., from b₁, b₂, and b_{2′}, respectively).

The constructed SO tgd consolidates the semantics of b₁, b₂, and b_{2′} under one merged mapping. Intuitively, since all (or at least a portion of) three basic SO tgds are applicable whenever the source pattern is given by T_{2′} and the target pattern is given by T₄, the resulting SO tgd takes the conjunction of the “behaviors” of the individual basic SO tgds.

With respect to correlations, a crucial point about the above construction is that a target expression may now be assigned multiple expressions. For example, in the above SO tgd, the target expression d·did is equated with two expressions: F[g] via b₁, and G[w,g] via b_{2′}. In other words, the semantics of the new constraint requires the values of the two Skolem terms to coincide. This is actually what it means to correlate b₁ and b_{2′}. Such a correlation can be represented, explicitly, as the following conditional equality (implied by the above SO tgd):

for w in Works, g in Group satisfying w·gno=g·gno and w·addr=“NY”
[symbol] F[g]=G[w,g]

The term “residual equality constraint” is used for such equality constraint where one member in the implied equality is a Skolem term while the other is either a source expression or another Skolem term. Such constraints have to be enforced at runtime when data exchange is performed with the result of the MapMerge operation. In general, Skolem functions are implemented as (independent) lookup tables, where for every different combination of the arguments, the lookup table gives a fresh new null. However, residual constraints will require correlation between the lookup tables. For example, the above constraint requires that the two lookup tables (for F and G) give the same value whenever w and g are tuples of Works and Group with the same gno value.

The other three merged SO tgds that are generated as a result of the completion of Phase 3 for the example in FIGS. 2-5 are listed below.

(s₁) from (T₁,T₃,b₁)
for g in Group
exists d in Dept
where d·did=F[g] and d·dname=g·gname

(s₆) from (T₂,T₅,b₁ [symbol] b₃):
for w in Works, g in Group satisfying w·gno=g·gno
exists p in Proj, d in Dept
where p·did=d·did
and d·did=F[g] and d·dname=g·gname
and p·pname=w·pname and p·budget=H₁[w] and p·did=H₂[w]

(s₉) from (T′₂,T₅,b₁ [symbol] b′₂ [symbol] b₃):
for w in Works, g in Group
satisfying w·gno=g·gno and w·addr=“NY”
exists p in Proj, d in Dept
where p·did=d·did
and d·did=F[g] and d·dname=g·gname
and p·pname=w·pname and p·budget=H₁[w] and p·did=H₂[w]
and d·did=G[w,g]

One aspect to note is that not all skeletons generate merged SO tgds. Although there were six earlier skeletons, only three generate mappings that are neither subsumed nor implied. One embodiment uses the technique for pruning subsumed or implied mappings as discussed in A. Fuxman et al. For an example of a subsumed mapping, consider the triple (T₁,T₄,b₁). A mapping for this is not generated because its behavior is subsumed by s₁, which includes the same basic component b₁ but maps into a more “general” tableau, namely T₃. A mapping into T₄, which is a larger (more specific) tableau, is not constructed without actually using the extra part of T₄. Implied mappings are those that are logically implied by other mappings. For example, the mapping that would correspond to (T₂,T₃,b₁) is logically implied by s₆: they both have the same premise (T₂), but s₆ asserts facts about a larger tableau (T₅, which includes T₃) and already covers b₁.

Finally, for the example given above with respect to FIGS. 2-5, three more residual equality constraints, arising from s₆, and stating the pairwise equalities of F[g], H₂[w] and G[w,g] (since they are all equal to p·did and d·did, which are also equal to each other) are obtained.

Since residual equalities cause extra overhead at runtime, it is worthwhile exploring when such constraints can be eliminated without changing the overall semantics. This optimization process is performed by the fourth phase 608 of the MapMerge operation. The fourth phase 608 is performed by the optimizer 112. In this phase the optimizer 112 performs a simplification process and also flags conflicts that may arise and that need to be addressed by the user. These conflicts occur when multiple mappings that map to the same portion of the target schema contribute with different, irreconcilable behaviors. In particular, the algorithm 600 of FIG. 6 shows that the schema mapping manager 104 initializes the list of failed substitutions F to F=Ø. The schema mapping manager 104 then repeats the following. Let U=FindNextSubstitution(Σ′,F). If U is a substitution candidate (i.e., not a failure) then if U cannot be successfully applied on Σ′ (i.e., Substitute (Σ′,U) fails) then the schema mapping manager 104 adds the fails substitution U to F until no more substitutions can be applied. The schema mapping merger 104 then returns (Σ′,F) as the output of the overall algorithm 600.

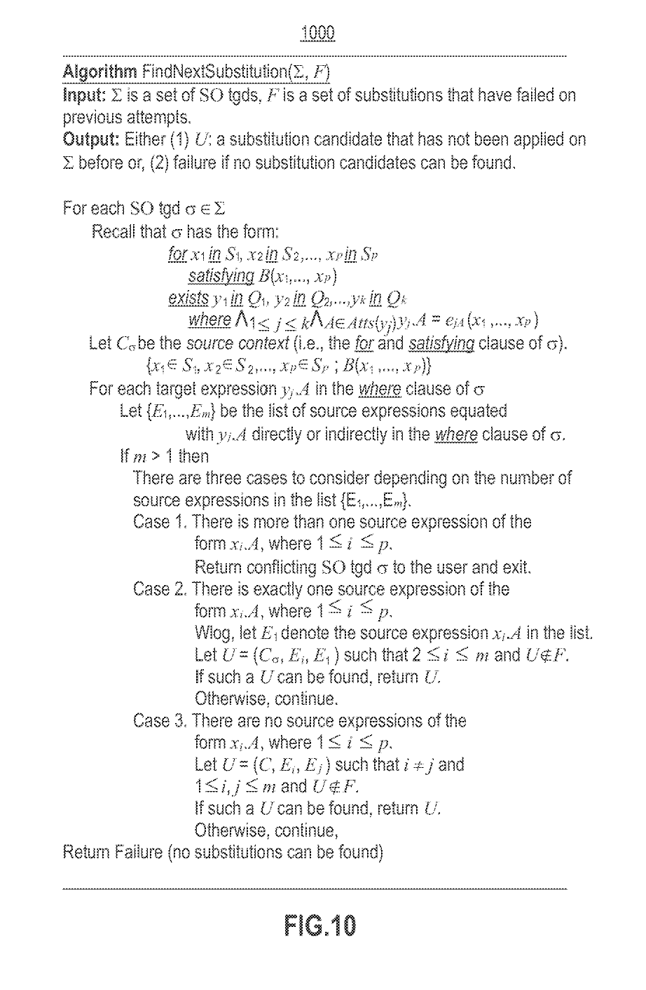

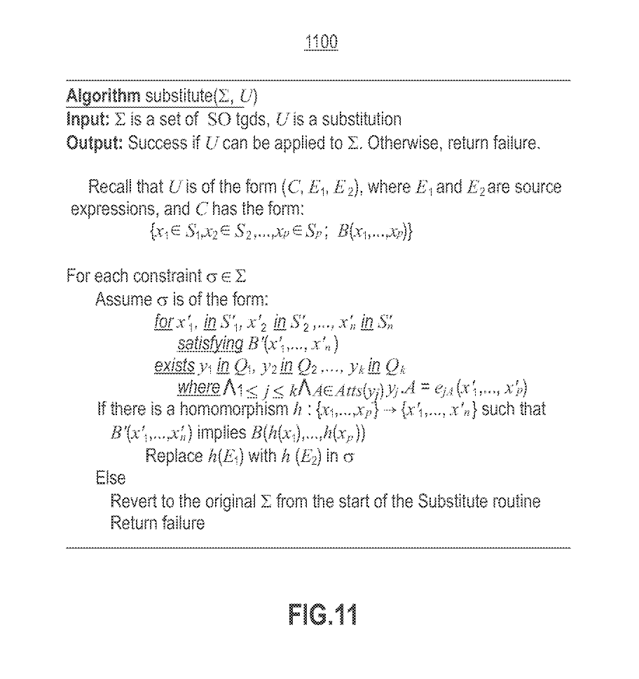

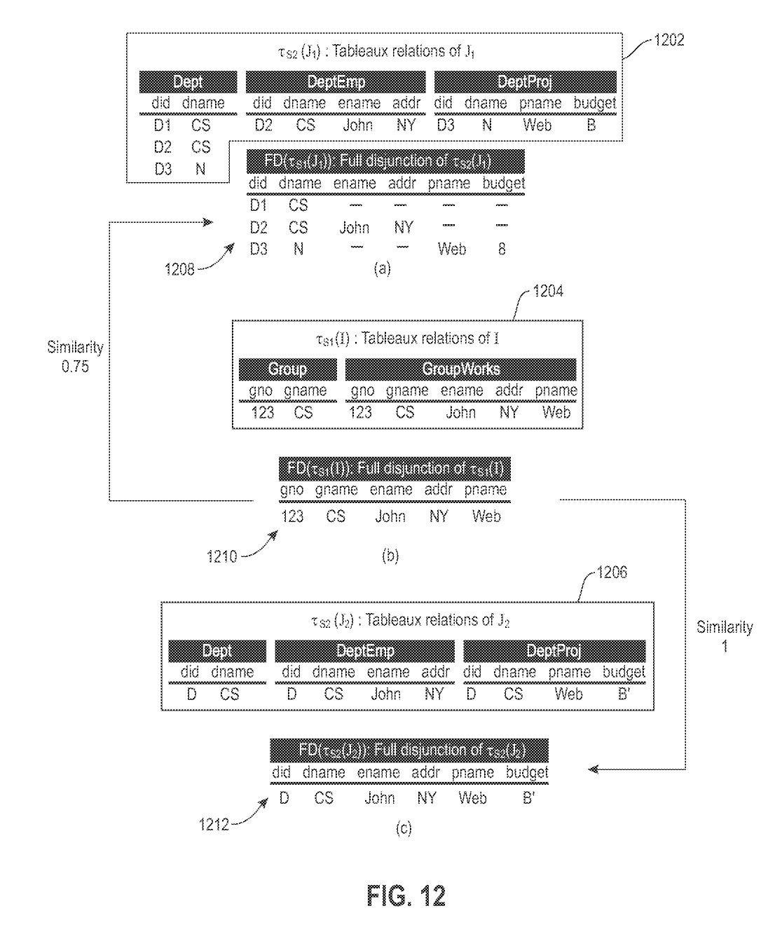

FIGS. 10-11 show pseudo code of the algorithms 1000, 1100 for the optimization process performed by the optimizer 112. In particular, the optimization process shown in FIGS. 10-11 eliminates as many Skolem terms as possible from the generated SO tgds. In one embodiment, for each residual equality constraint, one member of the equality is attempted to be substituted, globally, with the other member. If the substitution succeeds then there is one less residual equality constraint to enforce during runtime. Moreover, the resulting SO tgds are syntactically simpler.

Consider the earlier residual constraint stating the equality F[g]=G[w,g] (under the conditions of the for and satisfying clauses). The two Skolem terms F[g] and G[w,g] occur globally in multiple SO tgds. To avoid the explicit maintenance and correlation of two lookup tables (for both F and G), one embodiment attempts the substitution of either F[g] with G[w,g] or G[w,g] with F[g]. Care must be taken since such substitution cannot be arbitrarily applied. First, the substitution can only be applied in SO tgds that satisfy the preconditions of the residual equality constraint. For the current example, either substitution cannot be applied to the earlier SO tgd s₁, since the precondition requires the existence of Works tuple that joins with Group.

In general, a check is performed for the existence of a homomorphism that embeds the preconditions of the residual equality constraint into the for and where clauses of the SO tgd. The second issue is that the direction of the substitution matters. For example, substitute F[g] by G[w,g] in every SO tgd that satisfies the preconditions. There are two such SO tgds: s₈ and s₉. After the substitution, in each of these SO tgds, the equality d·did=F[g] becomes d·did=G[w,g] and can be dropped, since it is already in the where clause. Note, however, that the replacement of F[g] by G[w,g] did not succeed globally. The SO tgds s₁ and s₆ still refer to F[g]. Hence, the explicit correlation of the lookup tables for F and G is maintained. On the other hand, substitute G[w,g] by F[g] in every SO tgd that satisfies the preconditions. Again, there are two such SO tgds: s₈ and s₉. The outcome is different now: G[w,g] disappears from both s₈ and s₉ (in favor of F[g]); moreover, it did not appear in s₁ or s₆ to start with. It can be stated that the substitution of G[w,g] by F[g] has globally succeeded. Following this substitution, the constraint s₉ is implied by s₆: they both assert the same target tuples, and the source tableau T_{2′} for s₉ is a restriction of the source tableau T₂ for s₆. Hence from now the constraint s₉ can be discarded.

Similarly, based on the other residual equality constraint discussed above, the substitution of H₂[w] by F[g] can be applied. This affects only s₆ and the outcome is that H₂[w] has been successfully replaced globally. The resulting SO tgds, for the example of FIGS. 2-5, are:

(s₁) for g in Group
exists d in Dept
where d·did=F[g] and d·dname=g·gname

(s′₆) for w in Works, g in Group satisfying w·gno=g·gno
exists p in Proj, d in Dept
where p·did=d·did
   and d·did=F[g] and d·dname=g·gname
   and p·pname=w·pname and p·budget=H₁[w] and p·did=F[g]

(s′₈) for w in Works, g in Group
satisfying w·gno=g·gno and w·addr=“NY”
exists e in Emp, d in Dept
where e·did=d·did
   and d·did=F[g] and d·dname=g·gname
   and e·ename=w·ename and e·addr=w·addr and e·did=F[g]

As explained above, both s_{c} and s₈, can be simplified, by removing the assertions about Dept, since they are implied by s₁. The result is then identical to the SO tgds shown FIG. 5. It should be noted that the above example only covered residual equalities between Skolem terms. The case of equalities between a Skolem term and a source expression is similar, with the difference that only one substitution (to replace the Skolem term by the source expression) is formed.

The process shown in FIGS. 10-11 for eliminating residual constraints is an exhaustive process that forms each possible substitution and attempts to apply it on the existing SO tgds. If the replacement is globally successful, the residual equality constraint that generated the substitution can be eliminated. Then, the optimizer 112 goes on to eliminate other residual constraints on the rewritten SO tgds. If the replacement is not globally successful, the optimizer 112 tries the reverse substitution (if applicable). In general, it may be the case that neither substitution succeeds globally. In such case, the corresponding residual constraint is kept as part of the output of MapMerge operation. Thus, the outcome of the MapMerge operation is, in general, a set of SO tgds together with a set of residual equality constraints. For the example of shown in FIGS. 2-5 the latter set is empty.

The last issue that arises is the case of conflicts in mapping behavior. Conflicts can also be described via constraints, similar to residual equality constraints, but with the main difference that both members of the equality are source expressions (and not Skolem terms). To illustrate, it might be possible that a merged SO tgd asserts that the target expression d·dname is equal to both g·gname (from some input mapping) and with g·code (from some other input mapping, assuming that code is some other source attribute). Then, conflicting semantics are obtained with two competing source expressions for the same target expression. The optimization process shown in FIGS. 10-11 flags such conflicts, whenever they arise, and returns the mapping to the user to be resolved.

Evaluation

To evaluate the quality of the data generated based on the MapMerge operation performed by the schema mapping merger 104, a measure can be utilized that captures the similarity between a source and target instance by measuring the amount of data associations that are preserved by the transformation from the source to the target instance. This similarity measure was used in experiments to show that the mappings derived by the MapMerge operation are better than the input mappings.

This similarity measure captures the extent to which the “associations” in a source instance are preserved when transformed into a target instance of a different schema. For each instance, a single relation is computed that incorporates all (or at least a portion of) the natural associations between data elements that exist in the instance. There are two types of associations that are considered. The first type is based on the chase with referential constraints and is naturally captured by tableaux. As discussed above with respect to the second phase 604 of the MapMerge operation, a tableau is a syntactic object that takes the “closure” of each relation under referential constraints. The join query that is encoded in each tableau can then be materialized and all (or at least a portion of) the attributes that appear in the input relations can be selected (without duplicating the foreign key/key attributes). Thus, for each tableau a single relation is obtained, referred to as “tableau relation” that conveniently materializes together data associations that span multiple relations. For example, the tableau relations for the source instance I 402 in FIG. 4 (for tableaux T₁ and T₂ discussed above with respect to the second phase 604 of the MapMerge operation) are shown in box 1204 in FIG. 12. The tableau relations of an instance I of schema S is denoted as Σ_{S}(I), or simply Σ(I). The tableau relations τ(J₁) and τ(J₂) for the example in FIGS. 2-5 are also shown in boxes 1202 and 1206 in FIG. 12.

The second type of association that is considered is based on the notion of full disjunction. See for example, C. A. Galindo-Legaria: Outerjoins as Disjunctions, SIGMOD Conference, pages 348-358, 1994; and A. Rajaraman and J. D. Ullman: Integrating Information by Outerjoins and Full Disjunctions, PODS, pages 238-248, 1996, which are hereby incorporated by reference in their entireties. The full disjunction of relations R₁, . . . , Rₖ, denoted as FD(R₁, . . . , Rₖ), captures in a single relation all (or at least a portion of) the associations (via natural join) that exist among tuples of the input relations. The reason for using full disjunction is that tableau relations by themselves do not capture all (or at least a portion of) the associations. For example, consider the association that exists between John and Web in the earlier source instance J₂. There, John is an employee in CS, and Web is a project in CS. However, since there is no directed path via foreign keys from John to Web, the two data elements appear in different tableau relations of τ(J₂) (namely, DeptEmp and DeptProj). On the other hand, if the natural join between DeptEmp and DeptProj is taken the association between John and Web will appear in the result. Thus, to capture all (or at least a portion of) such associations, an additional step is applied that computes the full disjunction FD(τ(I)) of the tableau relations. This generates a single relation that conveniently captures all (or at least a portion of) the associations in an instance I of schema S. Each tuple in this relation corresponds to one association that exists in the data.

Operationally, full disjunction performs the outer “union” of all (or at least a portion of) the tuples in every input relation, together with all (or at least a portion of) the tuples that arise via all (or at least a portion of) possible natural joins among the input relations. To avoid redundancy, minimal union is used instead of union. This means that in the final relation, tuples that are subsumed by other tuples are pruned. A tuple t is subsumed by a tuple t′ if for all (or at least a portion of) attributes A such that t·A≠null, it is the case that t′·A=t·A. The full details of implementing full disjunction is omitted for simplicity, but such implementation is part of the experimental evaluation.

For the example shown in FIGS. 2-5 example, it is shown FD(τ(J₁)), FD(τ(I)), and FD(τ(J₂)) at 1208, 1210, and 1212 of FIG. 12, respectively. There, the ‘-’ symbol is used to represent the SQL null value. It is noted that FD(τ(J₂)) connects now all (or at least a portion of) three of John, Web and CS in one tuple.

Now that all (or at least a portion of) of the associations are in a single relation, one on each side (source or target), they can be compared. More precisely, given a source instance I and a target instance J, the similarity between I and J is defined by defining the similarity between FD(τ(I)) and FD(τ(J)). However, when tuples between FD(τ(I)) and FD(τ(J)) are compared, arbitrary pairs of attributes should not be compared. To avoid capturing “accidental” preservations, tuples are compared based only on their compatible attributes that arise from the mapping. In the following, it is assume that all (or at least a portion of) the mappings that are needed to evaluate implement the same set V of correspondences between attributes of the source schema S and attributes of the target schema T. This assumption is true for mapping generation algorithms, which start from a set of correspondences and generate a faithful implementation of the correspondences (without introducing new attribute-to-attribute mappings). It is also true for the MapMerge operation and its input, since the MapMerge operation, in one embodiment, does not introduce any new attribute-to-attribute mappings that are not already specified by the input mappings. Given a set V of correspondences between S and T, attribute A of S is compatible with an attribute B of T if either there is a direct correspondence between A and B in V, or (2) A is related to an attribute A′ via a foreign key constraint of S, B is related to an attribute B′ via a foreign key constraint of T, and A′ is compatible with B′. For the example in FIGS. 2-5, the pairs of compatible attributes (from source to target) are: (gname,dname), (ename,ename), (addr,addr), (pname,pname).

Definition 1 (Tuple similarity): Let t₁ and t₂ be two tuples in FD(τ(I)) and, respectively, FD(τ(J)). The similarity of t₁ and t₂, denoted as Sim(t₁,t₂), is defined as:

$$\frac{\begin{matrix}\vert \{ A ∈ Atts ( {t}_{1} ) \vert ∃ B ∈ Atts ( {t}_{2} ) , A and B compatible , \\ {t}_{1} \cdot A = {t}_{2} \cdot B \neq null \} \vert\end{matrix}}{\vert \{ A ∈ Atts ( {t}_{1} ) \vert ∃ B ∈ Atts ( {t}_{2} ) , A and B compatible \} \vert}$$

Sim(t₁,t₂) captures the ratio of the number of values that are actually exported from t₁ to t₂ versus the number of values that could be exported from t₁ according to V. For instance, let t₁ be the only tuple in FD(τ(I)) 1210 in FIG. 12 and t₂ the only tuple in FD(τ(J₂)) 1212 in FIG. 12. Then, Sim(t₁,t₂) is 1.0, since t₁·A=t₂·B for every pair of compatible attributes A and B. Now, let t₂ be the first tuple in FD(τ(J₁)). Since only t₁·gname=t₁·dname out of four pairs of compatible attributes, Sim(t₁,t₂) is 0.25.

Definition 2 (Instance similarity): The similarity between FD(τ(I)) and FD(τ(J)) is

$$Sim ( FD ( τ ( I ) ) , FD ( τ ( J ) ) = {\sum }_{{t}_{1} ∈ FD ( τ ( I ) )}^{ } {max}_{{t}_{2} ∈ FD ( τ ( J ) )} Sim ( {t}_{1} , {t}_{2} ) .$$

FIG. 12 depicts the similarities Sim(FD(τ(I)), FD(τ(J₁)) and Sim (FD(τ(I)),FD(τ(J₂))). The former similarity score is obtained by comparing the only tuple in FD(τ(I)) with the best matching tuple (i.e., the second tuple) in FD(τ(J₁))).

Experiments

To evaluate the MapMerge operation the inventors conducted a series of experiments on a set of synthetic mapping scenarios as well as on two real-life mapping scenarios from the biological domain. The synthetic mapping scenarios transform data from a de-normalized source schema with a single relation to a target schema containing a number of hierarchies, with each hierarchy having at its top an “authority” relation, while other relations refer to the authority relation through foreign key constraints. The target schema corresponds roughly to ontological schemas, which often contain top-level concepts that are referred to by many sub-concepts. The synthetic scenarios were also designed to scale so that both the running time performance of the MapMerge operation and the improvement in target data quality as the schemas increase in size can be measured.

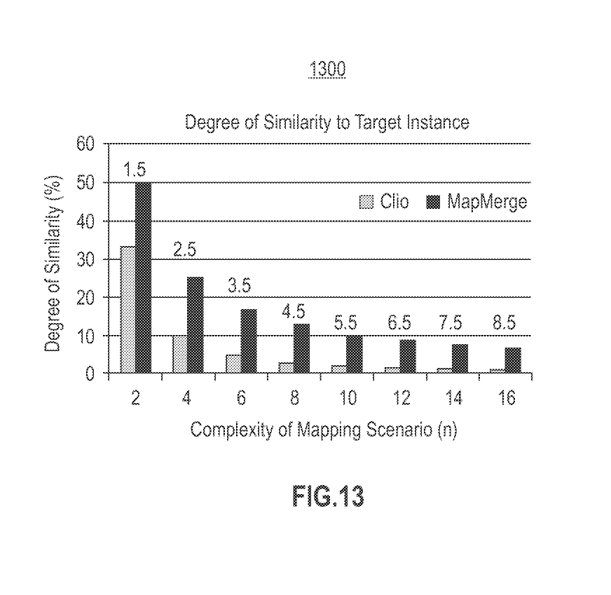

FIG. 13 illustrates a graph 13 showing the improvement in the quality of the generated data that was obtained by using MapMerge operation versus using Clio-generated mappings (See, for example, S. Melnik, P. A. Bernstein, A. Halevy, and E. Rahm: Supporting Executable Mappings in Model Management, SIGMOD, pages 167-178, 2005, which is hereby incorporated by reference in its entirety). In the experiment, the Clio-generated mappings are used as input to the MapMerge operator. Thus, the experiment shows the benefit of using MapMerge on top of Clio mappings. The parameter n that describes the complexity of the mapping scenario in terms of schemas is shown on the x-axis. On the y-axis, the degree of similarity of the source instance I to the target instance J that is generated (by using MapMerge or Clio mappings) is shown. Here, the degree of similarity of I to J is computed as the ratio of Sim(FD(τ(I)), FD(τ(J))) to Sim(FD(τ(I)), FD(τ(I))), where the latter represents the ideal case where every tuple in FD(τ(I)) is preserved by the target instance. It should be noted that the latter quantity simplifies to the expression |FD(τ(I))|.

As FIG. 13 shows, the degree of similarity decreases as n increases (for both MapMerge and Clio mappings). The reason is that, as n becomes larger, the source relation is broken into a larger number of uncorrelated top-level target concepts. Thus, the increased loss of associations from the source to the target is inevitable. However, the relative improvement when using the MapMerge operation on top of the Clio mappings (shown as the numbers on top of the bars) increases substantially, as n becomes larger. The reason is that MapMerge operation is able to correctly map to an entire hierarchy (for each top-level concept) without any loss of associations, while Clio mappings have only a limited ability.

Operational Flow Diagrams

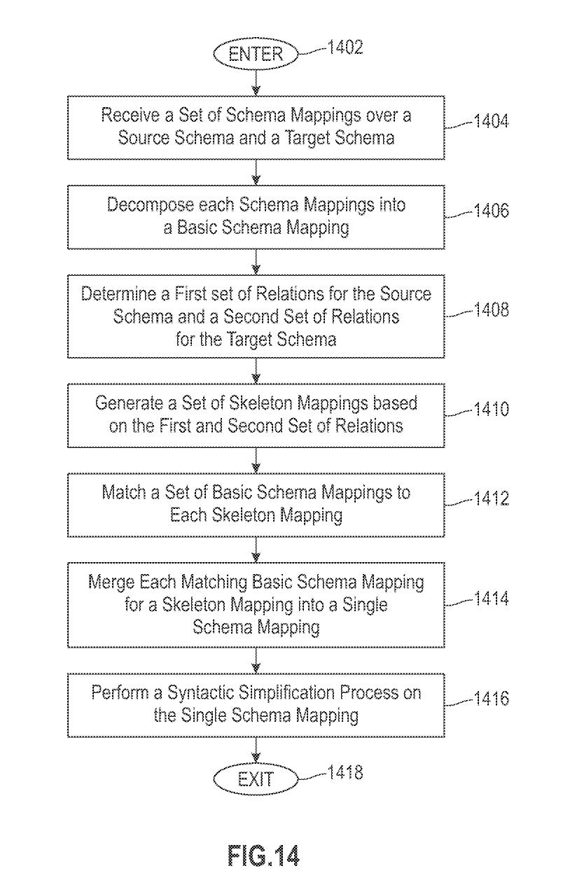

Referring now to FIG. 14, the flowchart(s) and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

FIG. 14 is an operational flow diagram illustrating one overview of a process for correlating schema mappings. It should be noted that a more detailed discussion with respect to this process has already been given above with respect to FIGS. 1-13 and is shown in greater detail in the pseudo code for the algorithms 600, 700, 800, 900, 1000, 1100 discussed above. The operational flow of FIG. 14 begins at step 1402 and flows directly into step 1404. The schema mapping merger 104, at step 1404, receives a set of schema mappings over a source schema and a target schema. The schema mapping merger 104, at step 1406, decomposes each schema mappings into a basic schema mapping that specifies a mapping behavior for a single target relation and comprises a description of attributes within the single target relation.

The schema mapping merger 104, at step 1408, determines a first set of relations for the source schema and a second set of relations for the target schema. The first set of relations and the second set of relations are related by referential constraints within the source schema and the target schema. The schema mapping merger 104, at step 1410, generates a set of skeleton mappings (relation pairs) based on the first and second set of relations. The schema mapping merger 104, at step 1412, identifies, for each skeleton mapping, a set of basic schema mappings from the plurality of basic schema mappings that matches the skeleton mapping. The schema mapping merger 104, at step 1414, merges each matching basic schema mapping into a single schema mapping. The schema mapping merger 104, at step 1416, then performs a syntactic simplification process on the single schema mapping. The control flow then exits at step 1418.

Information Processing System

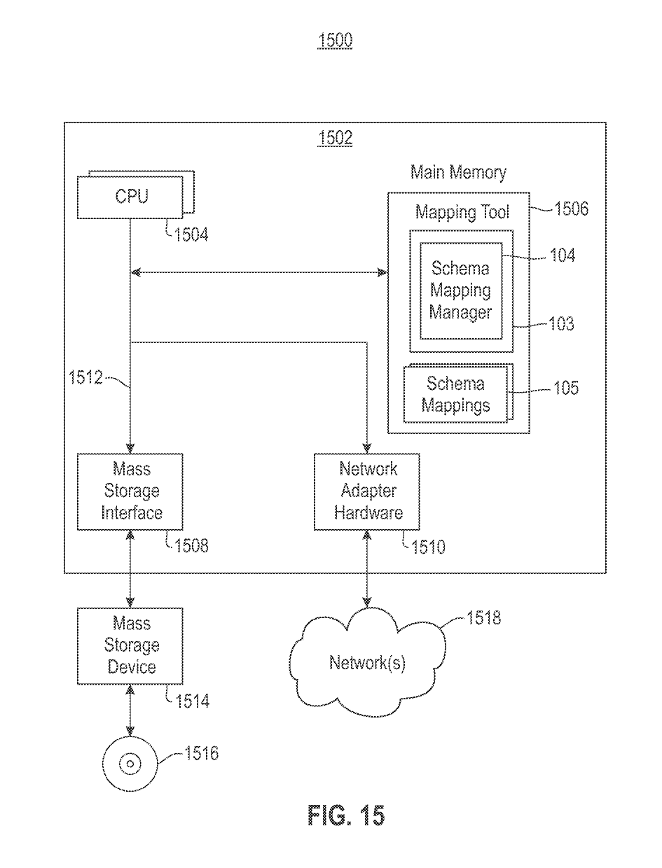

Referring now to FIG. 15, this figure is a block diagram illustrating an information processing system that can be utilized in embodiments of the present invention. The information processing system 1500 is based upon a suitably configured processing system adapted to implement one or more embodiments of the present invention (e.g., the user system 102 of FIG. 1). Any suitably configured processing system can be used as the information processing system 1500 in embodiments of the present invention.

The information processing system 1500 includes a computer 1502. The computer 1502 has a processor(s) 1504 that is connected to a main memory 1506, mass storage interface 1508, and network adapter hardware 1510. A system bus 1512 interconnects these system components. Although only one CPU 1504 is illustrated for computer 1502, computer systems with multiple CPUs can be used equally effectively. The main memory 1506, in this embodiment, comprises the mapping tool 103, the schema mapping merger 104 and its components, and the schema mappings 105.

The mass storage interface 1508 is used to connect mass storage devices, such as mass storage device 1514, to the information processing system 1500. One specific type of data storage device is an optical drive such as a CD/DVD drive, which can be used to store data to and read data from a computer readable medium or storage product such as (but not limited to) a CD/DVD 1516. Another type of data storage device is a data storage device configured to support, for example, NTFS type file system operations.

An operating system included in the main memory is a suitable multitasking operating system such as any of the Linux, UNIX, Windows, and Windows Server based operating systems. Embodiments of the present invention are also able to use any other suitable operating system. Some embodiments of the present invention utilize architectures, such as an object oriented framework mechanism, that allows instructions of the components of operating system to be executed on any processor located within the information processing system 1500. The network adapter hardware 1510 is used to provide an interface to a network 1518. Embodiments of the present invention are able to be adapted to work with any data communications connections including present day analog and/or digital techniques or via a future networking mechanism.

### Non-Limiting Examples

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been discussed above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments above were chosen and described in order to best explain the principles of the invention and the practical application, and to enable others of ordinary skill in the art to understand the invention for various embodiments with various modifications as are suited to the particular use contemplated.

1-7. (canceled)

8. A system comprising:
memory;
a processor communicatively coupled to the memory; and
a schema mapping merger communicatively coupled to the memory and the processor, the schema mapping merger configured to:
receive a set of schema mappings over a source schema and a target schema;
decompose each schema mappings into a basic schema mapping that specifies a mapping behavior for a single target relation and comprises a description of attributes within the single target relation, the decomposing generating a plurality of basic schema mappings;
determine a first set of relations for the source schema and a second set of relations for the target schema, wherein the first set of relations and the second set of relations are related by referential constraints within the source schema and the target schema;
pair each relation in the first set of relations to at least one relation in the second set of relations, wherein the pairing forms a plurality of relation pairs between the first set of relations and the second set of relations in the form of (T,T′), where T is a source portion of a relation pair and T′ is a target portion of the relation pair;
identify, for at least one relation pair, a set of basic schema mappings from the plurality of basic schema mappings that matches the relation pair; and
merge each basic schema mapping in the set of basic schema mappings into a single schema mapping.

9. The system of claim 8, wherein each schema mapping in the set of schema mappings is a set of second-order tuple generating dependencies, and wherein each basic schema mapping in the plurality of basic schema mappings is a basic second-order tuple generating dependency.

10. The system of claim 8, wherein the schema mapping merger is configured to identify a set of basic schema mappings from the plurality of basic schema mappings that matches the relation pair by:
analyzing each basic schema mapping in the plurality of basic schema mappings with respect to each of the relation pairs in the plurality of relation pairs;
determining, for each basic schema mapping with respect to each relation pair, if there is a pair (h, g) of homomorphisms that embed the basic schema mapping into the relation pair such that h at least maps a set of source variables of the basic schema mapping to a set of variables in T, and g at least maps a set of target variables identified by the basic schema mapping to a set of variables in T′; and
in response to the pair (h, g) of homomorphisms existing, determining that the basic schema mapping matches the relation pair.

11. The system of claim 8, wherein the schema mapping merger is configured to merge each basic schema mapping in the set of basic schema mappings into a single schema mapping by:
adding a set of source variable bindings associated with T to a portion of the single schema mapping that identifies source variables;
adding a set of target variable bindings associated with T′ to a portion of the single schema mapping that identifies variables required to be in the target schema;
adding a set of equalities in T to the single schema mapping;
adding a set of equalities in T′ to a constraint portion of the single schema mapping that identifies constraints on at least one of the set of source variable bindings and the set of target variable bindings; and
adding a set of constraints from each of the basic mappings in the set of basic schema mappings to the constraint portion of the single schema mapping.

12. The system of claim 8, wherein the schema mapping merger is further configured to:
determine, in response to the each basic schema mapping being merged, that an equality constraint within the single schema mapping indicates that a target expression is assigned a plurality of expressions; and
generate, in response to the equality constraint indicating that a target expression is assigned a plurality of expressions, a residual equality constraint as part of the single schema mapping that represents the equality constraint in a form where a first member of the equality constraint is a first Skolem term and a second member is one of a source expression and a second Skolem term.

13. The system of claim 8, wherein the schema mapping merger is further configured to:
determine, in response to the each basic schema mapping being merged, that an equality constraint within the single schema mapping indicates a target expression is assigned at least two source expressions;
associate the target expression with a flag indicating that a conflict has occurred; and
notify a user of the conflict.

14. A computer program product comprising a computer readable storage medium having computer readable program code embodied therewith, the computer readable program code comprising computer readable program code configured to:
receive a set of schema mappings over a source schema and a target schema;
decompose each schema mappings into a basic schema mapping that specifies a mapping behavior for a single target relation and comprises a description of attributes within the single target relation, the decomposing generating a plurality of basic schema mappings;
determine a first set of relations for the source schema and a second set of relations for the target schema, wherein the first set of relations and the second set of relations are related by referential constraints within the source schema and the target schema;
pair each relation in the first set of relations to at least one relation in the second set of relations, wherein the pairing forms a plurality of relation pairs between the first set of relations and the second set of relations in the form of (T, T′), where T is a source portion of a relation pair and T′ is a target portion of the relation pair;
identify, for at least one relation pair, a set of basic schema mappings from the plurality of basic schema mappings that matches the relation pair; and
merge each basic schema mapping in the set of basic schema mappings into a single schema mapping.

15. The computer program product of claim 14, wherein each schema mapping in the set of schema mappings is a set of second-order tuple generating dependencies, and wherein each basic schema mapping in the plurality of basic schema mappings is a basic second-order tuple generating dependency.

16. The computer program product of claim 14, wherein the computer readable program code is configured to identify a set of basic schema mappings from the plurality of basic schema mappings that matches the relation pair by:
analyzing each basic schema mapping in the plurality of basic schema mappings with respect to each of the relation pairs in the plurality of relation pairs;
determining, for each basic schema mapping with respect to each relation pair, if there is a pair (h, g) of homomorphisms that embed the basic schema mapping into the relation pair such that h at least maps a set of source variables of the basic schema mapping to a set of variables in T, and g at least maps a set of target variables identified by the basic schema mapping to a set of variables in T′; and
in response to the pair (h, g) of homomorphisms existing, determining that the basic schema mapping matches the relation pair.

17. The computer program product of claim 14, wherein the computer readable program code is configured to merge each basic schema mapping in the set of basic schema mappings into a single schema mapping by:
adding a set of source variable bindings associated with T to a portion of the single schema mapping that identifies source variables;
adding a set of target variable bindings associated with T′ to a portion of the single schema mapping that identifies variables required to be in the target schema;
adding a set of equalities in T to the single schema mapping;
adding a set of equalities in T′ to a constraint portion of the single schema mapping that identifies constraints on at least one of the set of source variable bindings and the set of target variable bindings; and
adding a set of constraints from each of the basic mappings in the set of basic schema mappings to the constraint portion of the single schema mapping.

18. The computer program product of claim 14, wherein the computer readable program code is further configured to:
determine, in response to the each basic schema mapping being merged, that an equality constraint within the single schema mapping indicates that a target expression is assigned a plurality of expressions; and
generate, in response to the equality constraint indicating that a target expression is assigned a plurality of expressions, a residual equality constraint as part of the single schema mapping that represents the equality constraint in a form where a first member of the equality constraint is a first Skolem term and a second member is one of a source expression and a second Skolem term.

19. The computer program product of claim 18, wherein the computer readable program code is further configured to:
eliminate one of the first Skolem term and the second Skolem term from the single schema mapping by substituting one of
the first Skolem term for the second Skolem term, and
the second Skolem term for the first Skolem term.

20. The computer program product of claim 14, wherein the computer readable program code is further configured to:
determine, in response to the each basic schema mapping being merged, that an equality constraint within the single schema mapping indicates a target expression is assigned at least two source expressions;
associate the target expression with a flag indicating that a conflict has occurred; and
notify a user of the conflict.
